(19) United States
(12) Patent Application Publication
(10) Pub. No.: US 2005/0051916 A1
(43) Pub. Date: Mar. 10, 2005

(54) Cooling media pack

(75) Inventors: David M. Kinder, The Woodlands, TX (US); Philip W. Tweeton, Willis, TX (US); Randy J. White, Humble, TX (US)

Correspondence Address: FOLEY AND LARDNER;SUITE 500, 3000 K STREET NW, WASHINGTON, DC, 20007, US

(73) Assignee: C.E. SHEPHERD CO., INC.

(21) Appl. No.: 10/656,230

(22) Filed: Sep. 8, 2003

(51) Int. Cl. B01F 3/04

(52) U.S. Cl. 261/112.2; 261/DIG. 11

(57) ABSTRACT

A cooling media pack is provided which is adapted to be used in either film-fill or splash-fill cooling towers. The pack is formed of a plurality of alternating sheets, each of which has an undulating shape, thereby defining a series of ridges in each sheet. Each of the ridges has a peak and trough. The sheets are oriented such that the troughs of one sheet are adjacent the peaks on an adjacent sheet. Further, the ridges of every other sheet are oriented at a first angle with respect to the horizontal and the ridges of the remaining sheets are oriented at a second angle with respect to the horizontal. Each of the sheets includes a plurality of voids which are designed to enhance the efficiency of the cooling media pack, inhibit fouling, and inhibit the formation and/or accumulation of bacteria.

### BACKGROUND OF THE INVENTION

It has long been recognized that the longer one can suspend hot water running through a cooling media pack (such as that used in a cooling tower) and increase the contact time with air pumped through the material, the more efficiently the hot water can being to approach the temperature of the entering air and, therefore, be cooled. However, slowing the velocity of the water can only be done by increasing the suspension time during which the water is enclosed in the media.

Unfortunately, the slower the velocity of the water in the media, the more likely suspended solids may settle out of the water and/or dissolved solids may crystallize and, in turn, settle out of the water, thereby creating an unwanted blockage or clogging effect. In addition, the blockage may develop bacteria which may be hazardous to one servicing a cooling tower housing the media. Further, this blockage, which is often referred to as “fouling,” may have a negative effect on both the traveling water and air currents and, therefore, may significantly decrease the overall efficiency performance of the cooling media. Worse, as the weight of a blockage increases, the weight of a cooling media in which the blockage is located also increases, possibly to the point of catastrophic failure. By way of example, the added weight may cause a cooling tower housing the media to implode and/or crush a support structure under it. All of these problems have only been exacerbated by government regulations which have greatly reduced the amount of treatment which may be applied to the hot water before it enters the media pack.

To address this clogging issue, various forms of “low” or “non” fouling medias have been presented. A first such form is made of solid sheet members. However, when assembled, solid sheet members encourage build-up of debris over the media support members. Moreover, solid sheet members depend solely on water filming onto the media for cooling and, therefore, do not include splashing. In a second such form, which employs vertical passages, the water exit velocity is increased, thereby decreasing the contact time of the air and water in the media pack. In addition, vertical fluted media promote channeling which, as a result of air always taking the path of least resistance, decreases cooling opportunity due to the inability of the air to penetrate and saturate heavy streams of water.

What is needed, therefore, is an apparatus that addresses at least one if not more of the deficiencies found in conventional cooling medias, as previously described. More particularly, the need exists for an approach to cool water efficiently while avoiding at least some of the fouling problems inherent in the prior art.

### SUMMARY OF THE INVENTION

One embodiment of the invention addresses a cooling media pack which includes a plurality of alternating sheets each of which, in turn, includes a plurality of ridges and a plurality of voids. Each sheet has an undulating shape. The ridges of every other sheet are oriented substantially in a first direction whereas the ridges of the adjacent sheets are oriented substantially in a different direction. The cooling media is adapted to be used in film-fill and splash-fill cooling towers.

In another embodiment of the cooling media pack, a ratio of the area occupied by the voids to the surface area of the sheets may be between about 0.20:1 and about 0.75:1.

In another embodiment of the cooling media pack, a ratio of the area occupied by the voids to the surface area of the sheets may be about 0.315:1.

In another embodiment of the cooling media pack, the cooling media pack may be adapted to enable water droplets to drop substantially vertically through voids in at least two consecutive ridges in a sheet.

In another embodiment of the cooling media pack, each of the ridges may include a peak and a trough.

In a further embodiment, the peaks of one sheet may be joined to the troughs of a sheet adjacent to it.

In another further embodiment, the ridges of each of the sheets may oriented at an angle between about 20° and about 50°, with respect to the horizontal.

In another further embodiment, the ridges of each of the sheets may be oriented at an angle of about 26.6°, with respect to the horizontal.

In another embodiment of the cooling pack, the voids may have substantially similar sizes and shapes.

In a further embodiment, the shape of the voids may be, for example, circles, triangles, squares, diamonds, rectangles, hexagons, ovals, teardrops, etc.

In another embodiment of the cooling pack, each of the sheets may be formed from a material such as, for example, plastic, metal, tile, paper, ceramic, etc.

In a further embodiment, the plastic may be, for example, PVC, HPVC, CPVC, etc.

In another embodiment of the cooling media pack, the cooling media pack is adapted to promote upward airflow therethrough.

In a further embodiment, the airflow may be substantially vertical.

In another embodiment of the cooling media pack, if the cooling tower is a film-fill cooling tower, the film-fill cooling tower may be either a counter-flow or cross-flow cooling tower.

The invention also addresses another cooling media pack which includes a plurality of alternating sheets each of which, in turn, includes a plurality of ridges and a plurality of voids. Each sheet has an undulating shape. The ridges of every other sheet are oriented substantially in a first direction whereas the ridges of the adjacent sheets are oriented substantially in a different direction. A ratio of the area occupied by the voids to the surface area of the sheets is between about 0.20:1 and about 0.75:1.

The invention also addresses another cooling media pack which includes a plurality of alternating sheets each of which, in turn, includes a plurality of ridges and a plurality of voids. Each sheet has an undulating shape. The ridges of every other sheet are oriented substantially in a first direction whereas the ridges of the adjacent sheets are oriented substantially in a different direction. The cooling media pack is adapted to inhibit the formation and/or accumulation of bacteria on the sheets.

These and other features, aspects, and advantages of the present invention will become more apparent from the following description, appended claims, and accompanying exemplary embodiments shown in the drawings.

### BRIEF DESCRIPTION OF THE DRAWINGS

FIG. 1 is side perspective view of a first sheet used in combination with like sheets and mirror image sheets to create a cooling media pack;

FIG. 2 is a front view of the sheet of FIG. 1 showing that ridges of the sheet are oriented at an angle with respect to the horizontal;

FIG. 3 is an upright perspective view of a sheet which is substantially the mirror image of the sheet of FIG. 1;

FIG. 4 shows a side view of a cooling media pack formed of a sheet of the type shown in FIG. 3 between two sheets of the type shown in FIG. 1; and

FIG. 5 is a cross-sectional view of the cooling media pack of FIG. 4.

### DETAILED DESCRIPTION OF PREFERRED EMBODIMENTS

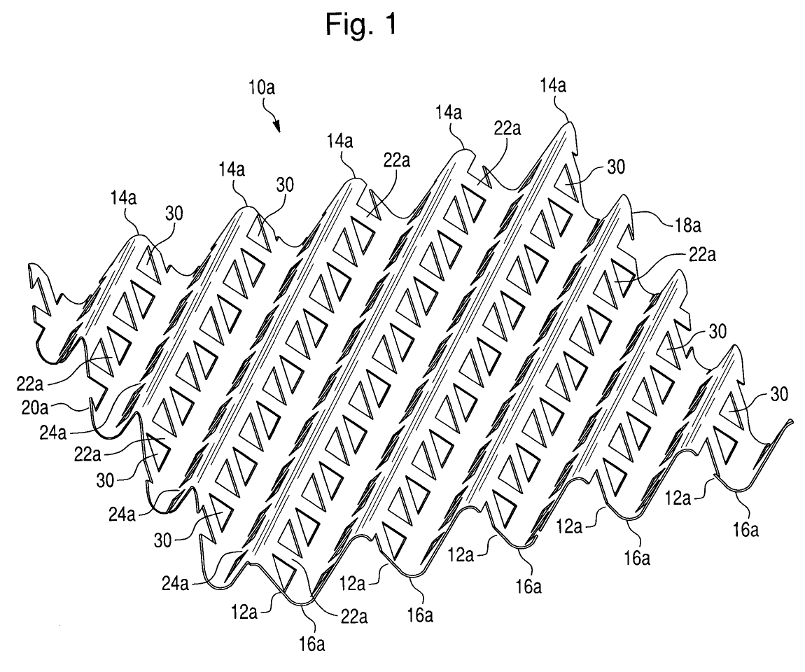

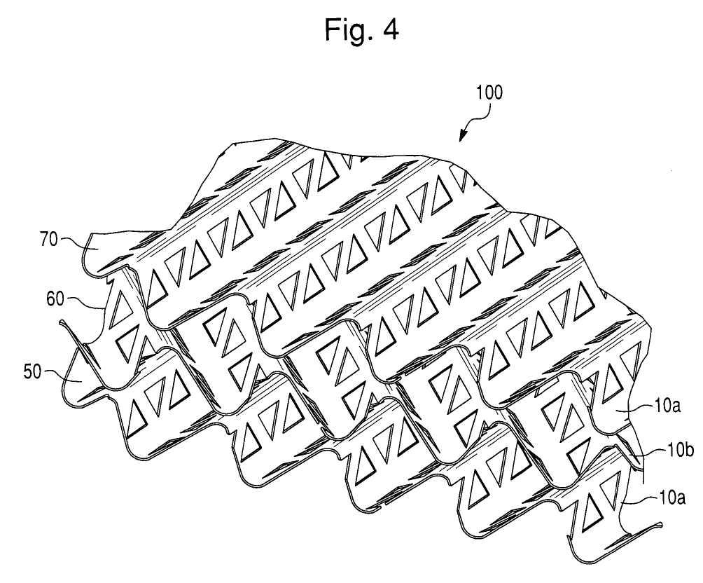

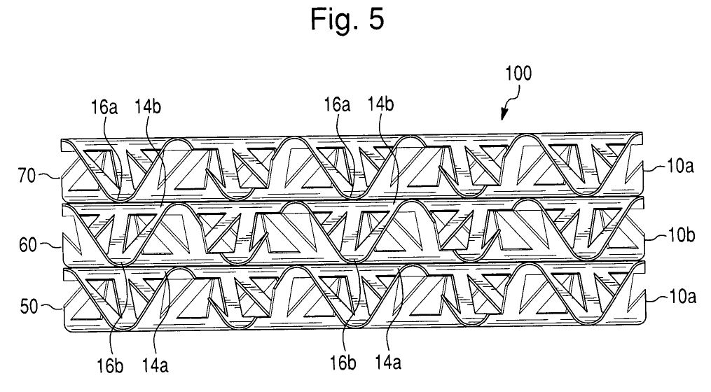

Presently preferred embodiments of the invention are illustrated in the drawings. An effort has been made to use the same reference numbers throughout the drawings to refer to the same or like parts. FIGS. 1-3 show one embodiment of undulating sheets 10A, 10B which may be used to form a cooling media pack 100, as shown in FIGS. 4 and 5. When the cooling media pack 100 is installed in a cooling tower, it becomes a heat exchange medium by which air pumped into the cooling media pack 100 is used to cool hot water flowing through the media pack 100 via a heat exchange relationship.

FIG. 1 shows side perspective view of a first thermoformed (which may also incorporate vacuum-forming) sheet 10A which, when combined with other like sheets 10A and substantially mirror image sheets 10B, may be used to form a cooling media pack 100, as described later in detail. It should be readily recognized that the sheet 10A may be formed by any suitable formation method, e.g., vacuum forming, blow-molding, casting, etc. Accordingly, although thermoforming a preferred method, this method of formation should not be construed as limiting the invention. Through the thermoformed process, the sheet 10A is preferably between 8 mm and 35 mm thick and may be formed of a variety of materials including plastic, metal, tile, paper, and ceramic. Further, if plastic is chosen as the material, the plastic may be, for example, PVC, HPVC, CPVC, etc.

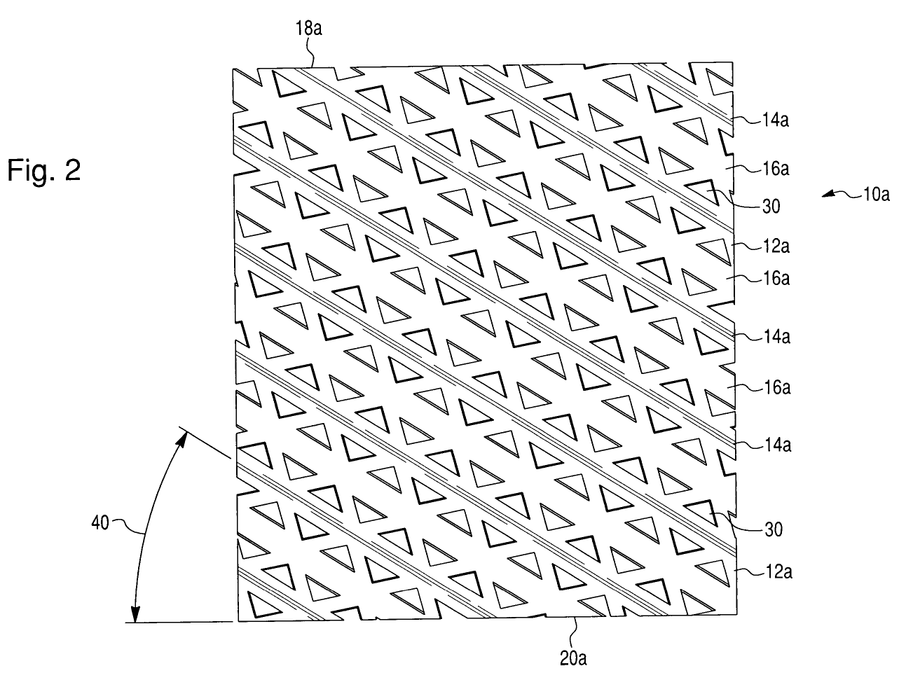

In FIG. 1, the sheet 10A is shown from a side view so that it is easier to see its undulating shape which defines a plurality of ridges 12A which are oriented substantially in a first direction. Each ridge 12A comprises a peak 14A and a trough 16A. It should be noted, however, that as the ridges 12A are at an angle with respect to top and bottom sides 18A, 20A of the sheet 10A (as best shown in FIG. 2), the ridges 12A at the top and bottom sides 18A, 20A of the sheet 10A will be incomplete, i.e., a portion of the ridges 12A at the top and bottoms sides 18A, 20A may lack a peak 14A or trough 16A. The portion of the ridges 12A which are lacking a peak 12 or a trough 16A will, of course, depend on where the sheet 10A is cut.

Each ridge 12A also has a front side 22A and a rear side 24A which connect the peaks 14A to the troughs 16A. Formed in the front side 22A and/or the rear side 24A, there are a plurality of voids 30. In the embodiment shown in FIG. 1, the sheet 10A has voids 30 formed in both the front side 22A and the rear side 24A of each of the ridges 12A. However, in other embodiments the voids 30 may only be formed on the front side 22A or on the rear side 24A. Further, in other embodiments, voids 30 may be formed in one or both sides 22A, 24A of every other ridge 12A (or every third ridge 12A, etc.) whereas the sides 22A, 24A of the intervening ridges 12A may have no (or fewer) voids 30.

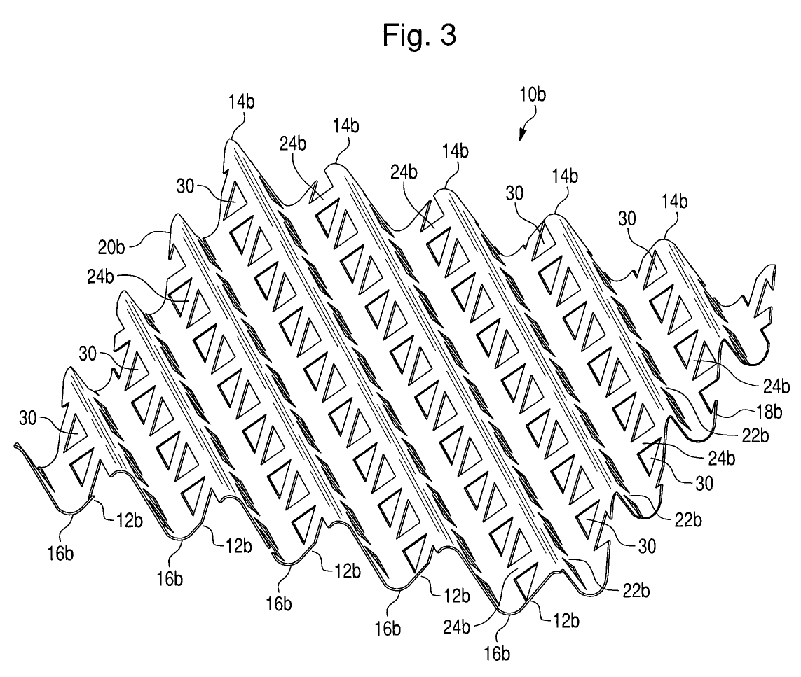

With respect to FIG. 3, there is shown a second sheet 10B having ridges 12B which run substantially in a different direction than the ridges 12A of the sheet 10A shown in FIG. 1. It should be understood that the sheet 10B is shown in its upright orientation whereas the sheet 10A in FIG. 1 is shown from a side view. In one embodiment, the second sheet 10B may substantially be the mirror image of the first sheet 10A. Further, the mirror image relationship may be obtained by inverting one of the first sheets 10A along an axis defined between the top side 18A and the bottom side 20A. As a result of this inversion, one type of sheet may be formed and used in both its non-inverted state to serve as the first sheet 10A and its inverted state to serve as the second sheet 10B, thereby reducing the cost of manufacturing the sheets 10A, 10B.

As shown, sheet 10B also comprises a plurality of ridges 12B each of which has a corresponding peak 14B, trough 16B, front side 22B, and rear side 24B. In addition, like sheet 10A, sheet 10B has a plurality of voids 30, a top side 18B, and a bottom side 20B. Although the ridges 12B of the sheet 10B may be oriented at any angle with respect to the bottom side 20B, it is preferable that the ridges 12B be formed at the same absolute valve angle at which the ridges 12A of the first sheet 10A are formed.

In other words, as shown in FIG. 2, if the angle 40 of the ridges 12A of the first sheet 10A is, for example, 35° with respect to the horizontal bottom side 20A, then the angle of the ridges 12B of the second sheet 10B would also be 35° with respect to the bottom side 20B. However, the angle of the ridges 12B of the second sheet 10B would be measured from the other side of the horizontal, i.e., the angle of the ridges 12B of the second sheet would be 180°—the angle 40 of the ridges 12A of the first sheet 10A. In the case of this example, the angle of the ridges 12B of the second sheet 10B would be 180°-35°=145°, as measured from the same horizontal by which the 35° angle of the ridges 12A of the sheet is measured. The absolute value of the angles 40 of the ridges 12A, 12B of the first and second sheets 10A, 10B, with respect to the bottom sides 20A, 20B, respectively, is between about 20° and about 50° and is preferably about 26.6°.

As shown in FIG. 4, a plurality of sheets 10A of the type shown in FIG. 1 may be alternated with, and joined to, a plurality of sheets 10B of the type shown in FIG. 3 to form a cooling media pack 100. In assembling the cooling media pack 100, a first sheet 50 (which may be of the type 10A, as shown) is provided. The peaks 14A of the sheet 50, which run substantially in a first direction, are then coated with a fastening material such as an adhesive, e.g., glue, resin, melted plastic, etc. When the peaks 14A are coated, a second sheet 60 (which may be of the type 10B, as shown) is lowered onto the first sheet 50. The troughs 16B of the second sheet 60, which run substantially in a different direction, rest on the coated peaks of the first sheet 50, thereby joining the first and second sheets 50, 60. As a result, the ridges 12A, 12B of the sheets 50, 60 form a crisscrossing pattern. Similarly, the peaks 14B of the second sheet 60 may be coated with a fastening material and a third sheet 70 (which may be of the type 10A, as shown) may be lowered onto the second sheet 60. The troughs 16A of the third sheet 70, which run substantially in a third direction (which may be substantially parallel to the first direction), would then bind to the peaks 14B of the second sheet 60.

The resultant cooling media pack 100 is shown in cross-section in FIG. 5. As shown, the troughs 16a of the top sheet 70 rests on the peaks 14b of middle sheet 60. Similarly, the troughs 16b of middle sheet 60 rest on the peaks 14a of bottom sheet 50.

It should be understood that although the described method of joining the sheets 10A, 10B involves a fastening material, the invention is not so limited. Rather, any conventional means of fastening may be employed such as, for example, screws, nuts/bolts, welding, etc.

When the cooling media pack 100 is assembled, the pack 100 is turned so that each substantially parallel sheet 10A, 10B is substantially vertical. As a result, air and water can move substantially vertically through the sheets 10A, 10B with some transverse movement along the sides 22A, 24A, 22B, 24B of the ridges 12A, 12B. Further, as a result of the vertical and transverse movements, the path of the water may be substantially zigzagged.

In one embodiment, the media pack 100 will be cylindrical in nature and be about 2′ to about 4′ tall and about 4′ to about 20′ in diameter. In addition, although the pack 100 is shown as having only three layers, this is for illustrative purposes only and it should be understood that a cooling media pack 100 used in either a cross-flow or counter-flow cooling towers would likely have more layers of alternating sheets 10A, 10B.

The voids 30 are essentially hollow areas in the sheets 10A, 10B through which downward flowing water and upward flowing air may pass substantially vertically. Further, in some embodiments, a water droplet may be able to pass directly through voids 30 formed in two or more consecutive ridges 12A in a sheet 10A, 10B. Water that does not fall through a void 30, runs along the sides 22A, 22B, 24A, 24B of the ridges 12A, 12B as a result of the ridges being at an angle 40 with respect to the horizontal.

Although the voids 30 are shown as being substantially triangular in shape, this is not required. Rather, the voids 30 may have a variety of shapes such as, for example, circles, squares, diamonds, rectangles, hexagons, ovals, teardrops, etc. Moreover, more than one void shape may be used in one or more sheets 10A. Similarly, although voids 30 are shown as being present on every sheet 10A, 10B, this is also not required. Rather, every other sheet, every third sheet, etc. may have voids 30. However, the ratio of the area consumed by the voids 30 to the surface area of the sheets 10A is preferably between about 0.20:1 and about 0.75:1. More preferably, the ratio is about 0.315:1.

The voids 30 of the assembled media pack 100 create a turbulent condition that aids in slowing the velocity of the water flowing downward therethrough and, therefore, increases the suspension time of the water in the media pack 100 which, in turn, facilitates cooling. As a result, the cooling media pack 100 provides air pumped therethrough an increased time in which to contact the water, thereby facilitating heat transfer from the water to the air. In addition, as a result of the increased exposure time, more air can pass through the cooling media pack 100 per given horsepower, thereby improving the performance efficiency of the cooling media pack 100 as compared to the prior art. Further, the increased performance efficiency of the media pack 100 improves the performance efficiency of a cooling tower housing it. In addition, the voids 30 also: (a) provide unwanted suspended solids and debris a necessary avenue of escape, thereby inhibiting fouling of the media pack 100; and (b) inhibit the opportunity for a pressure differential to develop through the media pack 100.

In addition to the aforementioned performance efficiency improvements generated by the cooling media pack 100 discussed herein, the media pack 100 also promotes a cleaner working environment. As a result of the voids 30, there is a reduced area on which harmful bacteria may form and/or accumulate, i.e., the cooling media pack 100 is adapted to inhibit the formation and/or accumulation of bacteria in a cooling tower. Therefore, the risk to one servicing a cooling tower housing the media pack is reduced.

The sheets 10A, 10B previously described provide a combination film/splash feature, i.e., an “all-in-one” sheet. Although the cooling media pack may be used in either splash-fill cooling towers (in either cross-flow or counter-flow designs) or in film-fill cooling towers (in counter-flow designs), it is preferably suited for use in film-fill, counter-flow cooling tower applications. This preference is a result of the substantially vertical passage for both the hot water and the induced air which is conducive to vertical counter-flow applications. However, the cooling media pack 100 can also be used in horizontal splash-fill cooling towers.

The sheets 10A, 10B also enable the cooling media pack 100 to have a combination film/splash feature, i.e., the pack 100 may be used not only in counter-flow cooling tower applications but also in cross-flow cooling tower applications. In a cross-flow applications, the media packs 100 can either be stood up on end (vertically) or laid (horizontally) in the heat transfer section of the cross-flow cooling tower. Regardless of vertical or horizontal installation, the fabricated pattern of the media pack 100 will allow vertical flow of the circulating fluids through and between the sheets 10A, 10B. The design of the media pack 100 (i.e., the orientation of the sheets 10A, 10B and pattern of the voids 30) provides positive assurance of uniformed fluid distribution over and through the entire cooling media pack 100. As the fluids are flowing vertically they are broken into smaller films and droplets, which are readily cooled by outside air which is drawn across and through the media pack 100 by means of an induced or natural draft current.

Enlarging the size of voids in a sheet has historically been discouraged. This discouragement was a direct result of the belief that larger voids would enable hot water to fall through a cooling media pack more easily. It was believed that the easier passage of the hot water would enable it to travel more quickly thereby reducing the time during which it could be cooled. Contrary to this conventional wisdom, the invention described herein uses large voids to create a turbulent condition which: (a) slows the hot water and, therefore, preserves the ability of the air to cool the hot water; (b) reduces fouling by providing less surface area on which debris may otherwise accumulate; and (c) inhibits the formation and/or accumulation of bacteria.

Although the aforementioned describes embodiments of the invention, the invention is not so restricted. It will be apparent to those skilled in the art that various modifications and variations can be made to the disclosed embodiments of the present invention without departing from the scope or spirit of the invention. For example, the invention may be adapted to other applications such as wastewater treatment facilities. Accordingly, these other cooling media packs are fully within the scope of the claimed invention. Therefore, it should be understood that the apparatus described herein is illustrative only and is not limiting upon the scope of the invention, which is indicated by the following claims.

1. A cooling media pack comprising:
a plurality of alternating sheets each of which comprises:
a plurality of ridges; and
a plurality of voids,
wherein each sheet has an undulating shape, wherein the ridges of every other sheet are oriented substantially in a first direction, wherein the ridges of the adjacent sheets are oriented substantially in a different direction, and wherein the cooling media is adapted to be used in film-fill and splash-fill cooling towers.

2. The cooling media pack according to claim 1, wherein a ratio of the area occupied by the voids to the surface area of the sheets is between about 0.20:1 and about 0.75:1.

3. The cooling media pack according to claim 2, wherein the ratio is about 0.315:1.

4. The cooling media pack according to claim 1, wherein the cooling media pack is adapted to enable water droplets to drop substantially vertically through voids in at least two consecutive ridges in a sheet.

5. The cooling media pack according to claim 1, wherein each of the ridges comprises a peak and a trough, and wherein the peaks of one sheet are joined to the troughs of a sheet adjacent to it.

6. The cooling media pack according to claim 5, wherein the ridges of each of the sheets are oriented at an angle between about 20° and about 50°, with respect to the horizontal.

7. The cooling media pack according to claim 5, wherein the ridges of each of the sheets are oriented at an angle of about 26.6°, with respect to the horizontal.

8. The cooling media pack according to claim 1, wherein the voids have substantially similar sizes and shapes.

9. The cooling media pack according to claim 8, wherein the shape of the voids is selected from the group consisting of circles, triangles, squares, diamonds, rectangles, hexagons, ovals, and teardrops.

10. The cooling media pack according to claim 1, wherein each of the sheets is formed from a material selected from the group consisting of plastic, metal, tile, paper, and ceramic.

11. The cooling media pack according to claim 10, wherein the plastic is PVC, HPVC, or CPVC.

12. The cooling media pack according to claim 1, wherein the cooling media pack is adapted to promote upward airflow therethrough, and wherein the airflow is substantially vertical.

13. The cooling media pack according to claim 1, wherein if the cooling tower is a film-fill cooling tower, the film-fill cooling tower is either a counter-flow or cross-flow cooling tower.

14. A cooling media pack comprising:
a plurality of alternating sheets each of which comprises:
a plurality of ridges; and
a plurality of voids,
wherein each sheet has an undulating shape, wherein the ridges of every other sheet are oriented substantially in a first direction, wherein the ridges of the adjacent sheets are oriented substantially in a different direction, and wherein a ratio of the area occupied by the voids to the surface area of the sheets is between about 0.20:1 and about 0.75:1.

15. The cooling media pack according to claim 14, wherein the ratio is about 0.315:1.

16. The cooling media pack according to claim 14, wherein each of the ridges comprises a peak and a trough, and wherein the peaks of one sheet are joined to the troughs of a sheet adjacent to it.

17. The cooling media pack according to claim 16, wherein the ridges of each of the sheets are oriented at an angle between about 20° and about 50°, with respect to the horizontal.

18. The cooling media pack according to claim 16, wherein the ridges of each of the sheets are oriented at an angle of about 26.6°, with respect to the horizontal.

19. The cooling media pack according to claim 14, wherein the voids have substantially similar sizes and shapes.

20. The cooling media pack according to claim 14, wherein each of the sheets is formed from a material selected from the group consisting of plastic, metal, tile, paper, and ceramic.

21. A cooling media pack comprising:
a plurality of alternating sheets each of which comprises:
a plurality of ridges; and
a plurality of voids,
wherein each sheet has an undulating shape, wherein the ridges of every other sheet are oriented substantially in a first direction, wherein the ridges of the adjacent sheets are oriented substantially in a different direction, and wherein the cooling media pack is adapted to inhibit the formation and/or accumulation of bacteria on the sheets.

22. The cooling media pack according to claim 21, wherein a ratio of the area occupied by the voids to the surface area of the sheets is between about 0.20:1 and about 0.75:1.

23. The cooling media pack according to claim 22, wherein the ratio is about 0.315:1.

24. The cooling media pack according to claim 21, wherein the voids have substantially similar sizes and shapes.

25. The cooling media pack according to claim 21, wherein each of the ridges comprises a peak and a trough, and wherein the peaks of one sheet are joined to the troughs of a sheet adjacent to it.

26. The cooling media pack according to claim 25, wherein the ridges of each of the sheets are oriented at an angle between about 20° and about 50°, with respect to the horizontal.

27. The cooling media pack according to claim 25, wherein the ridges of each of the sheets are oriented at an angle of about 26.6°, with respect to the horizontal.

28. The cooling media pack according to claim 21, wherein each of the sheets is formed from a material selected from the group consisting of plastic, metal, tile, paper, and ceramic.
